(19) United States
(12) Patent Application Publication
(10) Pub. No.: US 2002/0122906 A1
(43) Pub. Date: Sep. 5, 2002

(54) Manufacturing process for the blowing technique of a plastic container, specifically a small bottle designed for use in the field of cosmetics

(76) Inventors: Albert Pellicer, Oyonnax (FR); Patrick Rennie, Morristown, NJ (US)

Correspondence Address: YOUNG & BASILE, P.C., Suite 624, 3001 West Big Beaver Road, Troy, MI, 48084-3107, US

(21) Appl. No.: 09/886,799

(22) Filed: Jun. 21, 2001

(30) Foreign Application Priority Data
Mar. 1, 2001 (FR) 0103155

(51) Int. Cl. B29C 49/20; B32B 1/02

(52) U.S. Cl. 428/35.7; 264/516; 425/504

(57) ABSTRACT

Manufacturing process for the blowing technique of a plastic container and, more specifically, of a small bottle (6) designed for use in cosmetics.

The process comprises placement of at least one insert (10) in a mold and to keep the said insert (10) against the internal wall of the mold in such a way as to integrate the said insert (10) in the wall of the bottle (6) during the formation of the said bottle (6) in the said mold.

### FIELD OF THE INVENTION

The present invention involves a manufacturing process of a container and, more specifically, a plastic bottle specifically designed for use in the packaging of perfume and the manufacturing machine of the said bottle.

The goal of the machine according to this invention is to produce plastic bottles presenting a new aspect via the presence of an insert occupying a part of the surface of the said bottle.

### SUMMARY OF THE INVENTION

The production process of plastic bottles according to the invention consists of placing an insert in a mold, in order to keep the said insert against the internal wall of the mold in such a way as to integrate the said insert in the wall of the bottle during the operation forming the bottle in the said mold.

The bottle obtained presents the advantage of possessing one wall, the external surface of which is interrupted by the presence of the insert created in a plastic material different than that of the bottle and able to adhere to this other plastic material and giving the bottle an original look and/or feel.

Conforming to the process according to the invention the bottle will be formed in the mold via the blowing technique.

In a preferred method of production, it will present, preferably, a section that is notably ovoid shaped while the insert will form more specifically one of the lateral sides of the bottle.

The insert will initially be preformed and, in this case, in a curved shape.

The body of the bottle according to the invention will be produced out of a synthetic plastic material and preferably a polypropylene elastomer and the insert will be produced in the same plastic material but of a different grade in order to allow its solidification to the said body.

In a preferred method of production the body of the bottle will comprise an external layer created in a plastic material of a different grade than that of the plastic material making up the insert in such a way as to allow the adhering of this insert material to the external layer. The external layer will be created from a polypropylene elastomer.

The machine allows the implementation of the process of the invention characterized essentially by comprising means for stocking the inserts, means for gripping an insert, means allowing the introduction and positioning of the said insert in the corresponding pattern cavity of the mold, means for keeping the said insert in the said mold, means for the removal of the bottle once formed and integrating in its wall of the insert, and a control and command automation of operations.

The means allowing the positioning of the insert in the corresponding pattern cavity of the mold will be made up of, in a preferred method of production, a robot arm mounted in rotation around a horizontal axis and equipped with at least one hand mobile in rotation around a vertical axis, parallel to the axis of the said pattern cavity, coming in the course of rotation, after positioning of the hand opposite from the pattern cavity, pressing the insert against the wall of the pattern cavity that comprises means allowing keeping the insert in position against the pattern cavity in order to perform its transfer from the stocking unit in the mold.

The means of keeping the insert against the wall of the pattern cavity can consist of suction nozzles, integrated in the internal wall of the mold, that allow the creation in the internal wall, recessed zones, regularly distributed pressing the insert against he wall of the mold.

The mold will comprise at least one pattern cavity formed from two half shells between which the hand of the robot arm is returned mobile in rotation in such a way as to allow the placement of the insert against the wall of one of the half shells, the other part emerging from the insert being designed to come against the wall of the other shell during the closing of the mold which advantageously comprises two pattern cavities while the arm of the robot comprises two synchronized gripping hands in such a way as to position two inserts at the same time in the two pattern cavities of the mold.

The advantages and characteristics of the present invention will become clearer in the description that follows and which relates to the attached drawing, which represents a non-limiting method of production.

### BRIEF DESCRIPTION OF THE DRAWINGS

FIG. 1 represents a profile view of the manufacturing machine according to the invention.

FIG. 2 represents a view of the rear face of the preceding machine.

FIG. 3 represents a top view of the same machine.

FIG. 4a represents a transversally cut view of the mold of the machine according to the invention.

FIG. 4b represents a longitudinally cut view of the preceding mold.

FIG. 5a represents a partial longitudinally cut view in perspective of the preceding mold.

FIG. 5b represents a detailed view of a free end of the suction nozzles.

FIG. 6 represents a cut view according to A-A of he machine represented in FIG. 1.

FIG. 7 represents the placement phase of the insert in the pattern cavity of the mold.

FIG. 8 represents a perspective of a bottle created with the machine according the invention.

### DESCRIPTION OF PREFERRED EMBODIMENT

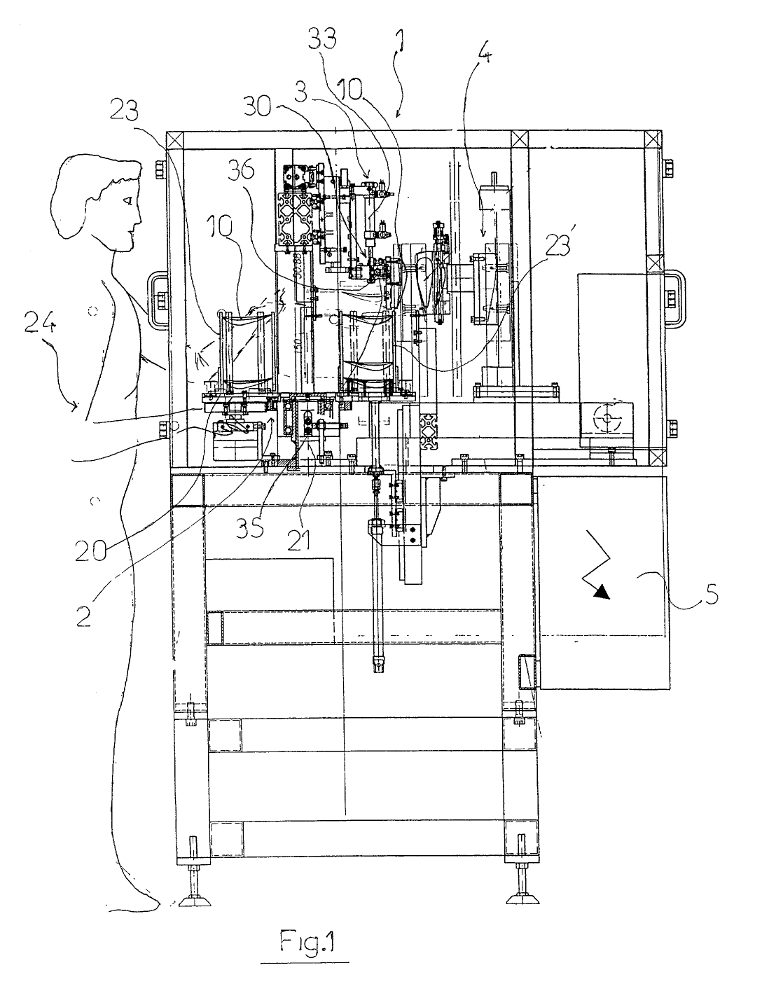

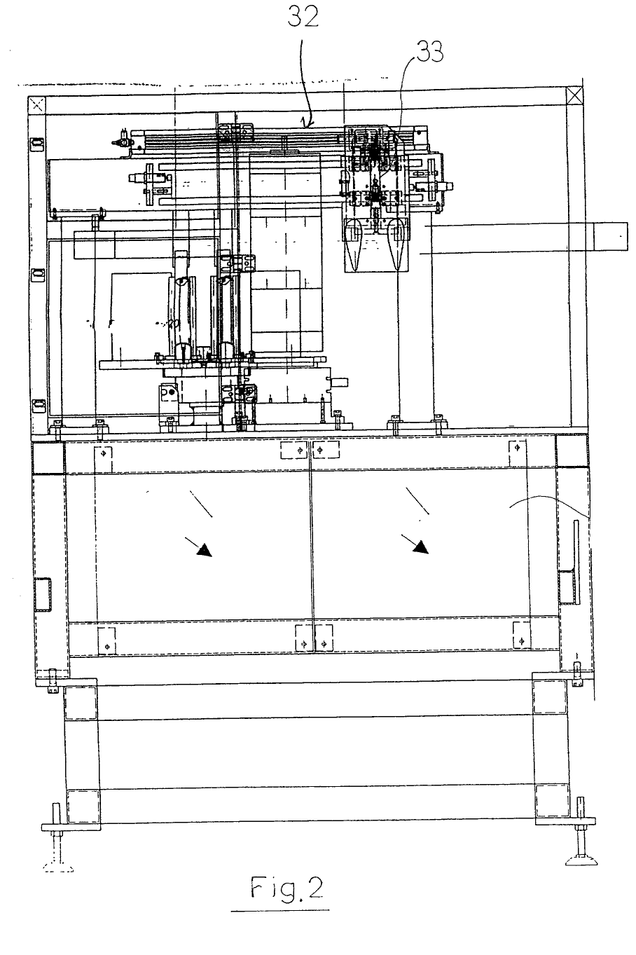

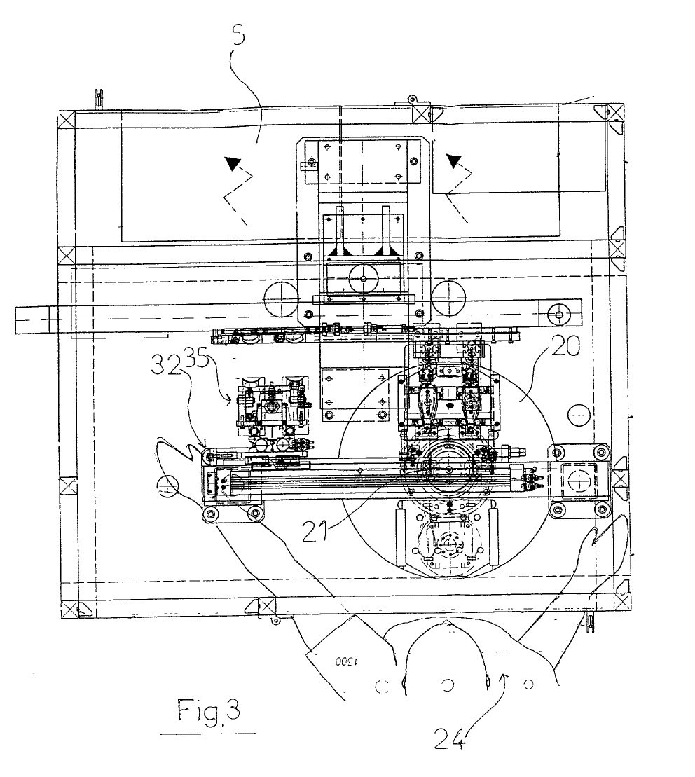

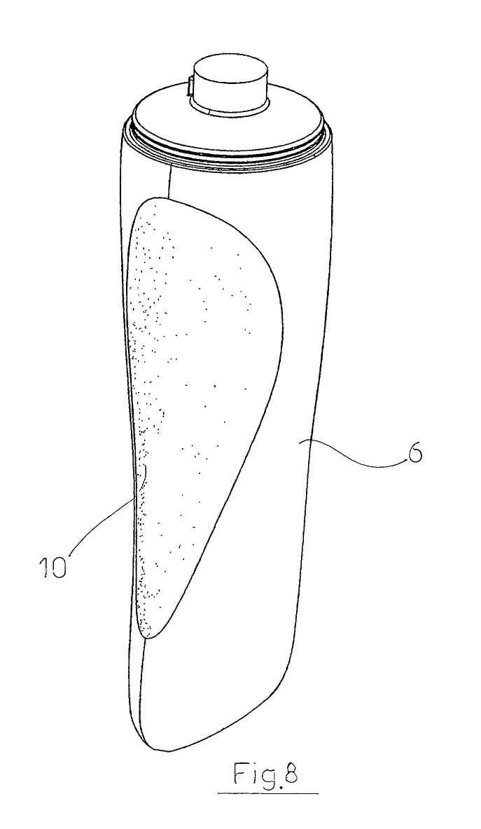

If one refers to FIGS. 1, 2, and 3 and to FIG. 8, one can see that a machine 1 allowing the manufacture of bottles containing an insert 10 is notably made up of means of stocking 2 the inserts 10, means of gripping 3 the inserts 10 in the stocking unit 2, of a mold 4 for the formation of bottles 6 via the blowing technique, of a control and command unit 5 of the machine 1.

The stocking unit 2 comprises a turntable 20 that turns around a vertical axis 21 supporting two stocking units 23, 23′ of the inserts 10, which are horizontally and manually stacked in the closest stocking unit 23′ by an operator 24.

The stocking unit 23′ the furthest from the operator 24 and which is diametrically opposite to the other stocking unit 23 is positioned via the gripping means 3 that are made up of a prehensile 30 guided in translation on a horizontal rail 31 parallel to the front face of the machine 1.

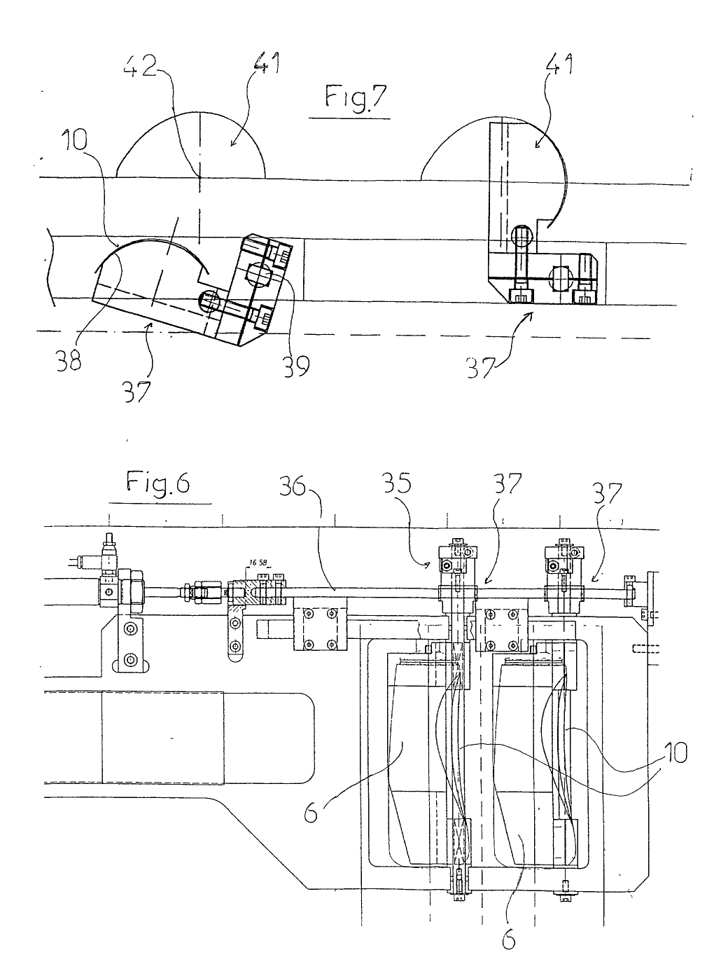

The prehensile 30 is equipped with guiding means 32 in the rail 31 and a hydraulic jack 33 oriented vertically and equipped at the free end of its rod 34 with a gripping arm 35, articulated around a horizontal axis 36 parallel to the rail 31, supporting two gripping hands 37 (FIG. 6).

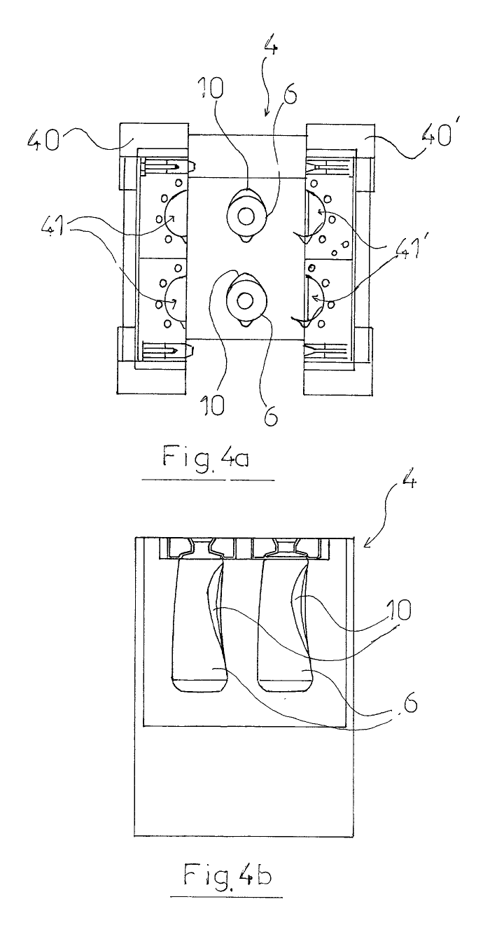

The mold 4 is made up of two pattern cavities each formed via the assembly of two cavities 41 and 41′ respectively pierced in two half shells 40, 40′, as one can see in FIG. 4a, allowing the formation at each molding operation two bottles 6 each equipped with an insert 10 on their lateral side.

FIG. 4b shows two bottles 6 in the course of formation in the mold 4 with two inserts 10 attached respectively to bottles 6.

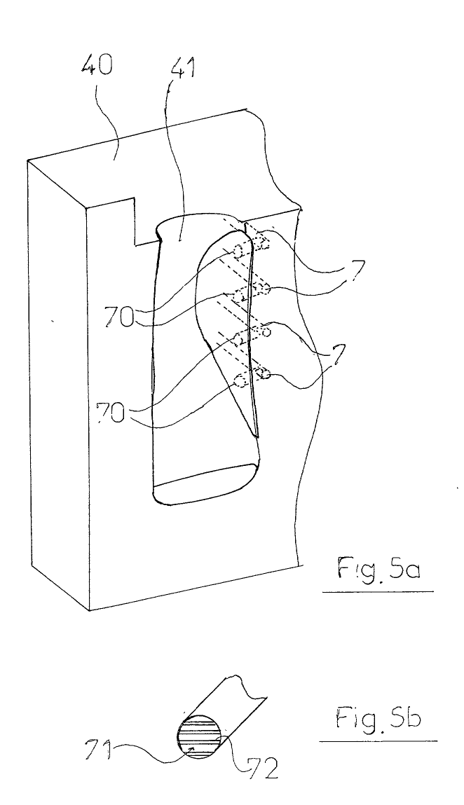

FIG. 5a shows an insert 10 positioned in the cavity 41 of one 40 of the half shells 40, 40′ and positioned straddling the edge of the said cavity 41 forming the junction with the cavity 41 ′ of the half shell 40′, the part of the insert 10 that emerges from the cavity 41 being designed to be pressed against the internal wall of the cavity 41′ corresponding to the other half shell 40′, not represented in this figure.

The inserts 10 have an oblong and curved shape and are attached to one of the lateral sides of the corresponding bottle 6.

One can also see on FIG. 5a that each insert 10 is kept in the cavity 41 of the mold 4 via suction nozzles 7 connected to a source, not represented, allowing the creation of a recess whose effect is the pressing of the insert against the internal wall of the cavity 41. One will note that the other half shell 40′ can also contain suction nozzles in order to hold the insert 10.

In addition, in such a way that the suction created at the exit of each nozzle 7 doesn't damage the zone of the insert 10 that is in contact with, each suction nozzle 7 is equipped at its free end 70, as one can see in FIG. 5b, a grate 71 formed from horizontal grooves 72 spaced at a certain distance in order to not mark the inserts 10. In addition the dimensions of the grooves and their spacing will be adapted in order to conserve an efficient recess at the end of the nozzles 7. Also, the grate 71 will preferably be created from a piece of aluminum.

One can see on FIG. 6 that an insert 10 is placed in the corresponding pattern cavity of the mold 4 via a gripping hand 37 that comprises a plate 38 of a shape complementary to that of the insert 10 integrating means keeping the insert against the plate 38 such as the suction nozzles, not represented.

In order to place the insert 10 in the mold 4, the hand 37 is animated with a rotation movement around a vertical axis, parallel to the axis of the pattern cavity of the mold or of the parison designed to form the bottle. This rotation is performed on an angle of about 90° in order to press the insert 10 against a part of the cavity wall 41 of the corresponding half shell 40.

In this production mode, the robot arm 35 comprises two hands 37 synchronized in order to allow the placement of the two inserts 10 at the same time in the mold 4.

In addition, the hands 37 will be equipped with anti-electrostatic means in order to not disturb the parison in the mold designed to form the bottle.

The bottles 6 will preferably be produced in a plastic material such as a polypropylene elastomer known under the mark “ADFLEX” and the inserts will be created in a semi-rigid plastic material able to adhere to the plastic material of the bottles during the blowing operation and more specifically to an external layer covering the bottles and created in a plastic material identical to that of the insert but of a different grade in order to allow its attachment.

One will note that, without leaving the framework of the present invention, the containers and the inserts could be produced in other materials, such as metal for example.

What is claimed is:

1. Manufacturing process for the blowing technique of a plastic container and, more specifically, of a bottle (6) designed for use in cosmetics characterized by consisting of placing at least one insert (10) in a mold (4) and of keeping the insert (10) against the internal wall of the mold (4) in such a way as to integrate the insert (10) into the wall of the bottle (6) during the formation of the bottle (6) in the mold (4).

2. Manufacturing process according to claim 1 characterized by the insert (10) being kept pressed against the internal wall of the mold (4) in such a way that its external surface is made flush with the external surface of the bottle (6) formed.

3. Machine allowing the implementation of the process according to one of claims 1 to 2 characterized by comprises means (2) for stocking the inserts (10), means for gripping (3) at least one insert (10), means (37) allowing the introduction and positioning of the insert (10) in the mold (4), means for maintaining (7, 70) the insert (10) against the internal wall of the pattern cavity of the mold (4), means for discharging the bottle (6) integrating in its wall the said insert (10), and an automation (5) of the control and command of operations.

4. Machine according to claim 3 characterized by the maintaining means (7, 70) of the insert (10) in the mold (4) consisting of suction nozzles (7) integrated in the internal wall of the mold (4) allowing the creation of recessed zones, preferably distributed regularly.

5. Machine according to claim 4 characterized by the exit opening (70) of the suction nozzle (7) comprising a grate (71) allowing one to avoid the deformation of the insert (10) due to the suction effect, the grate (71) being adapted in such a way as to not mark the insert and to conserve a sufficient recess at the exit of the nozzles (7).

6. Machine according to claim 5 characterized by the grate (71) being made from a metallic piece, preferably aluminum.

7. Machine according to claim 5 or 6 characterized by the grate (71) being made up of horizontal grooves.

8. Machine according to any of the claims 3 to 7 characterized by the means of gripping (3) an insert (10) in a stocking unit (2) being made up of a robot arm (35) articulated around a horizontal axis (36) and supporting at least one gripping hand (37) mobile in rotation around a vertical axis (38) and comprising a plate (38) equipped with suction means allowing solidification of the insert (10) on the plate for its transfer from the stocking unit (23′) in the pattern cavity of the mold (4).

8. Machine according to claim 8 characterized by the hand (37) being equipped with anti-electrostatic means.

9. Machine according to one of claims 3 to 8 characterized by the pattern cavity of the mold (4) being formed via the assembly of two cavities (41, 41′) made, respectively, in two half shells (40, 40′) and by the insert (10) being placed straddling the joint of the two cavities (41, 41′) in the closed position of the mold (4).

10. Bottle (6) according to any of the preceding claims characterized by the body of the bottle (6) being created from a synthetic plastic material and preferably from a polypropylene elastomer and by the insert (10) being created in the same plastic material but of a different grade in order to allow its solidification to the said body.

11. Bottle (6) according to claim 10 characterized by containing an external layer created in a plastic material of a different grade than that of the plastic material making up the insert (10) in order to allow it to adhere to the insert with the external layer.

12. Bottle (6) according to claim 12 characterized by the external layer of the bottle (6) being created from a polypropylene elastomer.

13. Bottle (6) according to any of claims 10 to 12 characterized by the bottle (6) having an oblong shape with a notably oval cross-section and by the insert (10) being attached to one of its lateral sides by generally occupying the entire height of the said bottle.
